(19) United States
(12) Patent Application Publication
(10) Pub. No.: US 2023/0247934 A1
(43) Pub. Date: Aug. 10, 2023

(54) SEED METERING APPARATUS

(71) Applicant: Jeffrey M. Reynolds, Corfu, NY (US)

(72) Inventor: Jeffrey M. Reynolds, Corfu, NY (US)

(21) Appl. No.: 18/090,952

(22) Filed: Dec. 29, 2022

Related U.S. Application Data
(60) Provisional application No. 63/304,585, filed on Jan. 29, 2022.

(51) Int. Cl. A01C 7/10; A01C 7/16

(52) U.S. Cl. CPC A01C 7/102; A01C 7/16

(57) ABSTRACT

A seed metering apparatus includes a seed hopper; a seed cup operatively connected to the seed hopper via an opening; and a valve mechanism, operatively connected between the seed hopper and the seed cup, configured to control a flow of seed from the seed hopper to the seed cup.

### PRIORITY INFORMATION

The present application claims priority, under 35 U.S.C. § 119(e), from U.S. Provisional Patent Application, Ser. No. 63/304,585, filed on Jan. 29, 2022. The entire content of U.S. Provisional Patent Application, Ser. No. 63/304,585, filed on Jan. 29, 2022, is hereby incorporated by reference.

### BACKGROUND

Conventional planting machines utilizing various types of grain drills including cup feed, external fluted roll, and internal double run types. Conventional planting machines employing the cup feed type may only be used on flat land for otherwise the flow of seed to and through the planting units is uneven and irregular from unit to unit.

Other problems encountered in the operation of a planting machine include following the contour of the ground closely negotiating lumpy soil conditions, forming a furrow of the proper depth and properly spacing the plants when planting.

Conventional tillage shanks have been provided with a delivery tube for the purpose of placing fertilizer or other substance below the surface of the ground at the same time the moving shank is cutting through and working the soil. Some conventional shank assemblies include a tube that has been permanently welded to the shank at a fixed location. In other conventional situations, the farmer may obtain tubes separately from the shanks and then weld the tubes to the shanks.

An example of a conventional planting machine is illustrated in FIG. 1. As illustrated in FIG. 1, seed 140, which has been placed in the hopper 93 passes through the entrance 109 into the chamber formed by the wall 114, the closed end 106, and the inner drum 104. The seed 140 passes through aperture 110 into the holes 99 of the rotating drum 94 as the seed 140 passes by the aperture 110. The elongation of the aperture 110 ensures efficiency in the filling of the holes 99.

A vertically disposed L-shaped internal wall 114 attaches between the end 106 and the portion of the inner drum 104 distal therefrom forming a container which includes the entrance 109 and aperture 110. A seed driving mechanism (not shown) is affixed to the inner drum 104 and inner wall 114 for effecting positive drilling of the seed.

The seed 140, in the holes 99, is then carried by the drum 94, a portion of the seed sliding against the drum 105, into alignment with the seed driving mechanism 115 and the passage 111. The seed 140 falls, aided both by gravity and the action of the driving mechanism, out of the hole 99, through a passage (not shown), into and through a seed tube (not shown) to the ground.

Another example of a conventional planting machine is illustrated in FIG. 2. As illustrated in FIG. 2, seed 140 originates in a seed hopper 10. The seed hopper 10 is operatively connected to a seed cup 20, through an opening or aperture 15. The opening or aperture 15 enables the seed 140 to travel from the seed hopper 10 to the seed cup 20, via gravity. Located in the seed cup 20 is a metering mechanism 30 that meters the seed 140 from the seed cup 30 to a seed tube 40. The metering mechanism 30 regulates the flow of seed 140 into seed tube 40, thereby regulating the spacing of the seed 140 in the row being planted.

Other examples of conventional planting machines are disclosed in U.S. Pat. Nos. 3,951,306; 4,079,362; 4,162,744; 4,221,305; 4,243,154; 4,254,897; 4,379,664; 5,402,741; 5,601,209; 6,672,228; and 8,001,913; and Published US Patent Application Numbers: 2007/0039528 and 2008/0110382. The entire contents of U.S. Pat. Nos. 3,951,306; 4,079,362; 4,162,744; 4,221,305; 4,243,154; 4,254,897; 4,379,664; 5,402,741; 5,601,209; 6,672,228; and 8,001,913; and Published US Patent Application Numbers: 2007/0039528 and 2008/0110382 are hereby incorporated by reference.

In these various conventional planting machines, the seed metering mechanism is driven in accordance with the associated tilling device. In other words when the tilling device is active (tilling the soil) the seed metering mechanism is active.

Moreover, in these various conventional planting machines, the seed flow from the seed hopper to the seed cup is not controlled such that if there is seed in the seed cup and the associated tilling device is active, the seed metering mechanism is providing seed to the seed tube. This can lead to seed waste and the overlapping of planted seed.

Therefore, it is desirable to provide a solution to control the flow of the seed from the seed hopper to the seed cup to prevent seed waste.

Moreover, it is desirable to provide a solution to control the flow of the seed from the seed hopper to the seed cup to prevent overlapping of planted seed.

Furthermore, it is desirable to provide a solution to control the flow of the seed from the seed hopper to the seed cup to prevent overlapping of planted seed and seed waste.

### BRIEF DESCRIPTION OF THE DRAWINGS

The drawings are only for purposes of illustrating various embodiments and are not to be construed as limiting, wherein:

FIG. 1 illustrates a prior art planting machine;

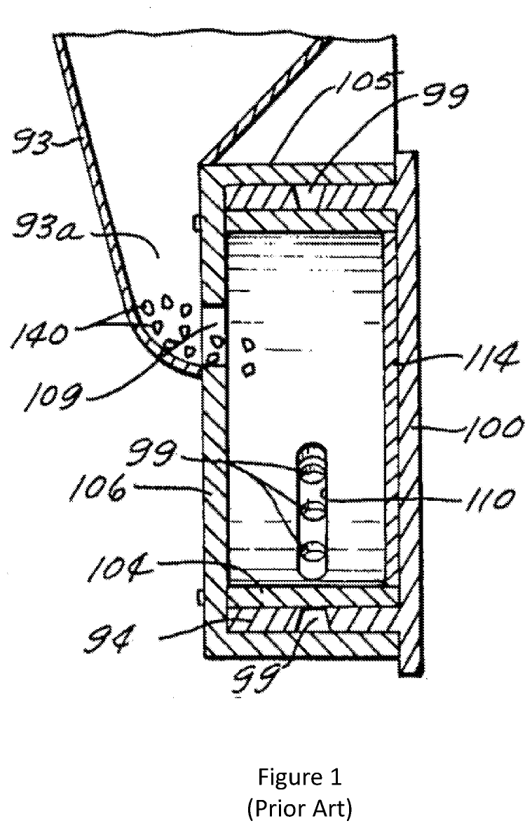

FIG. 2 illustrates another prior art planting machine;

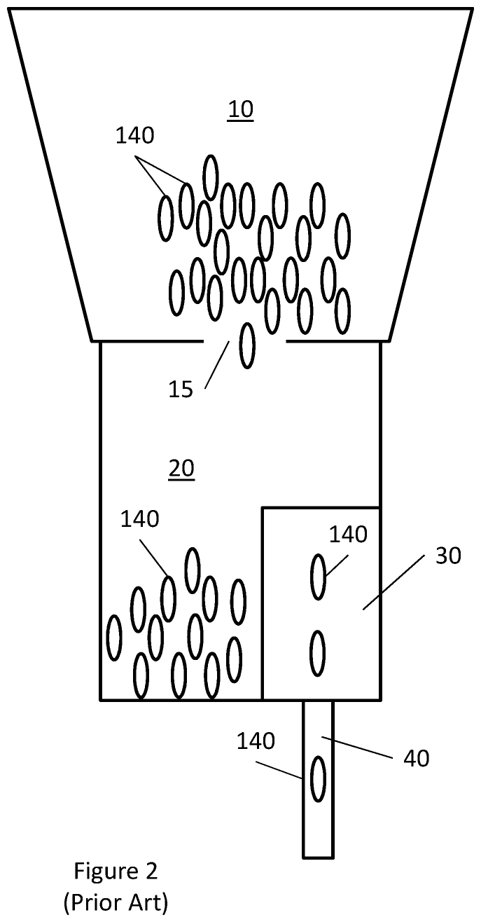

FIG. 3 illustrates an open state of a planting machine that controls the flow of the seed from the seed hopper to the seed cup;

FIG. 4 illustrates a closed state of a planting machine that controls the flow of the seed from the seed hopper to the seed cup; and

FIG. 5 shows a block diagram of the controlling of the flow of the seed from the seed hopper to the seed cup.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

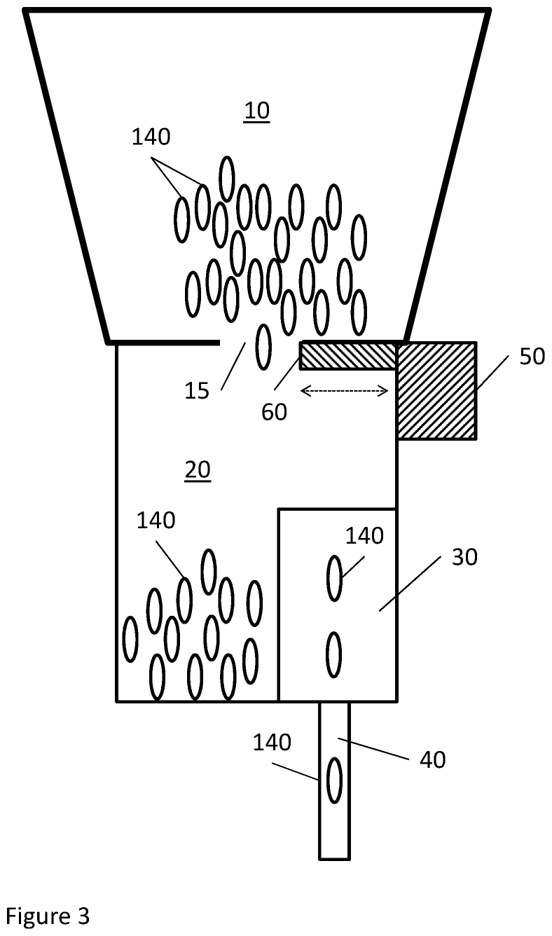

FIG. 3 illustrates an open state of a planting machine that controls the flow of the seed 140 from a seed hopper 10 to a seed cup 20. As illustrated in FIG. 3, seed 140 originates in a seed hopper 10. The seed hopper 10 is operatively connected to a seed cup 20, through an opening or aperture 15. The opening or aperture 15 enables the seed 140 to travel from the seed hopper 10 to the seed cup 20, via gravity. Located in the seed cup 20 is a metering mechanism 30 that meters the seed 140 from the seed cup 30 to a seed tube 40. The metering mechanism 30 regulates the flow of seed 140 into seed tube 40, thereby regulating the spacing of the seed 140 in the row being planted.

FIG. 3 further illustrates a knife or plate 60, which is bi-directionally driven by a solenoid 50. As illustrated in FIG. 3, solenoid 50 has driven the knife or plate 60 into an open state such that seed 140 can travel from the seed hopper 10 to the seed cup 20, through opening or aperture 15, via gravity.

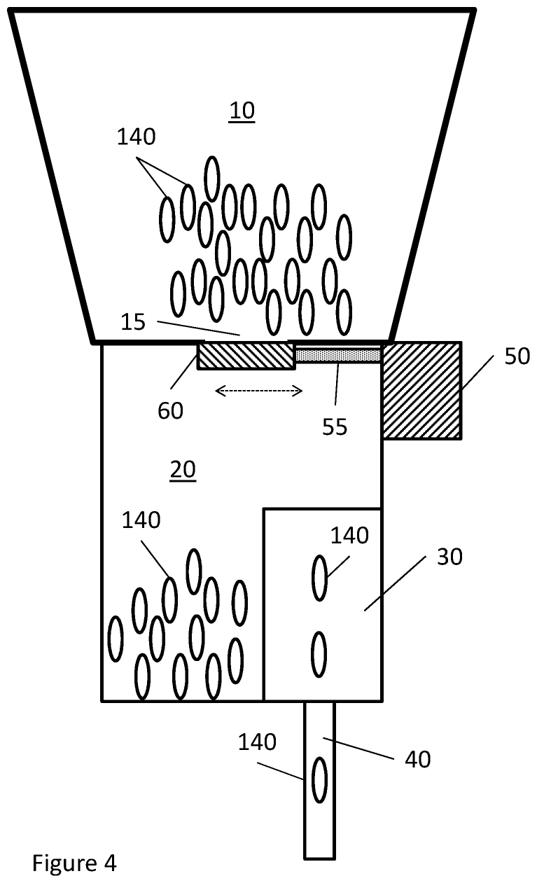

FIG. 4 illustrates a closed state of a planting machine that controls the flow of the seed 140 from a seed hopper 10 to a seed cup 20. As illustrated in FIG. 4, seed 140 originates in a seed hopper 10. The seed hopper 10 is operatively connected to a seed cup 20, through an opening or aperture 15. The opening or aperture 15 enables the seed 140 to travel from the seed hopper 10 to the seed cup 20, via gravity. Located in the seed cup 20 is a metering mechanism 30 that meters the seed 140 from the seed cup 30 to a seed tube 40. The metering mechanism 30 regulates the flow of seed 140 into seed tube 40, thereby regulating the spacing of the seed 140 in the row being planted.

FIG. 4 further illustrates a knife or plate 60, which is bi-directionally driven by a solenoid 50 and shaft 55. As illustrated in FIG. 4, solenoid 50 has driven the knife or plate 60 into a closed state such that seed 140 cannot travel from the seed hopper 10 to the seed cup 20, through opening or aperture 15, via gravity, because the knife or plate 60 is covering the opening or aperture 15.

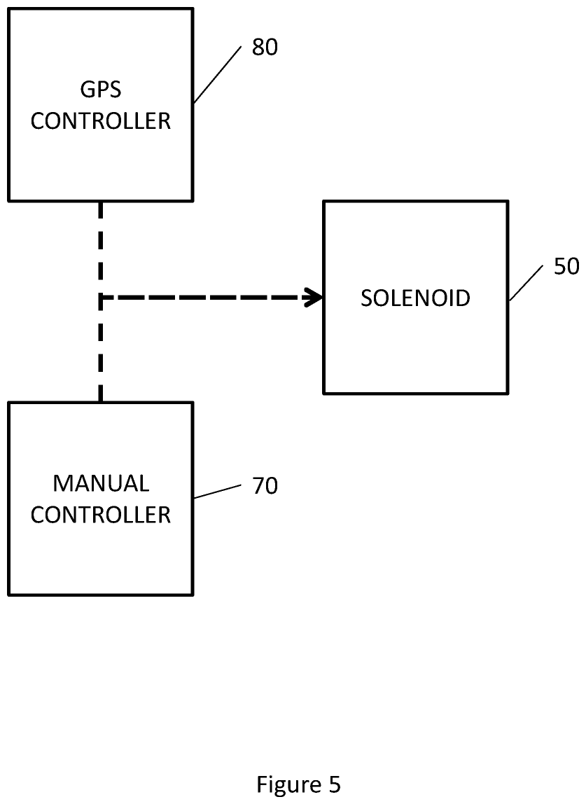

FIG. 5 shows a block diagram of the controlling of the flow of the seed from the seed hopper to the seed cup. As illustrated in FIG. 5, the solenoid 50 may be controlled by a GPS (Global Positioning Satellite) based controller 80 or a manual controller 70 or both.

The GPS based controller 80 includes a processor (not shown), a user interface (not shown), and a GPS Antenna (not shown) to receive a GPS signal to determine the location of the planting machine. A user can input the GPS coordinates of a field to be planted into the GPS based controller 80 either manually or by positioning the GPS based controller 80 at the boundaries of the field to be planted and collecting the GPS coordinates therefrom.

When in operation, the GPS based controller 80 determines the current position and direction of the planting machine and compares the current position with the previous positions that the planting machine has traverse during the seeding process. Based upon this information, the GPS based controller 80 can determine if the current position and direction needs seeding.

If the current position and direction needs seeding, the GPS based controller 80 sends a signal to the solenoid 50 to put the planting machine in an open state; i.e., moving the knife or plate 60 away from the opening or aperture 15, as illustrated in FIG. 3.

If the current position and direction does not need seeding, the GPS based controller 80 sends a signal to the solenoid 50 to put the planting machine in a closed state; i.e., moving the knife or plate 60 over the opening or aperture 15, as illustrated in FIG. 4.

The GPS based controller 80 may also be provided with the flow rate of the seed from the seed hopper to the seed cup such that the GPS based controller 80 can cause the knife or plate 60 over the opening or aperture 15, as illustrated in FIG. 4 prior to reaching an end of a row so that when the planting machine reaches the end of the row, the seed in the seed cup has been exhausted, thereby preventing seed waste.

The manual controller 70 enables the operator to control the state of the planting machine. The manual controller 70 may send a signal to the solenoid 50 to put the planting machine in an open state; i.e., moving the knife or plate 60 away from the opening or aperture 15, as illustrated in FIG. 3.

Moreover, the manual controller 70 may send a signal to the solenoid 50 to put the planting machine in a closed state; i.e., moving the knife or plate 60 over the opening or aperture 15, as illustrated in FIG. 4.

Alternatively, the manual controller 70 may send a signal to the solenoid 50 to override the signal from the GPS based controller 80.

In summary, a planting machine includes a valve mechanism between the seed hopper to control the flow of seed from the seed hopper to the seed cup to prevent overlapping of planted seed and/or seed waste.

The valve mechanism may be controlled automatically based on the planting machine's GPS coordinates or a may be controlled manually by a user.

A seed metering apparatus comprises a seed hopper; a seed cup operatively connected to the seed hopper via an opening; a bi-directional member for closing the opening; and a solenoid, operatively connected to the bi-directional member, to move the bi-directional member between an open state and a closed state; the open state corresponding to the opening being open and the closed state corresponding to the opening being closed.

The seed metering apparatus may further comprise a seed tube operatively connected to the seed cup.

The seed cup may include a metering mechanism to regulate a flow of seed into the seed tube.

The seed metering apparatus may further comprise a manual controller to manually control the solenoid.

The seed metering apparatus may further comprise a global positioning satellite based controller to automatically control the solenoid.

The manual controller may be configured to override the global positioning satellite based controller.

A seed metering apparatus comprises a seed hopper; a seed cup operatively connected to the seed hopper via an opening; and a valve mechanism, operatively connected between the seed hopper and the seed cup, configured to control a flow of seed from the seed hopper to the seed cup.

The valve mechanism may include a bi-directional member and a solenoid, operatively connected to the bi-directional member, to move the bi-directional member between an open state and a closed state; the open state corresponding to the valve mechanism being open and the closed state corresponding to the valve mechanism being closed.

The seed metering apparatus may further comprise a seed tube operatively connected to the seed cup.

The seed cup may include a metering mechanism to regulate a flow of seed into the seed tube.

The seed metering apparatus may further comprise a manual controller to manually control the valve mechanism.

The seed metering apparatus may further comprise a global positioning satellite based controller to automatically control the valve mechanism.

The manual controller may be configured to override the global positioning satellite based controller.

It will be appreciated that several of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

What is claimed is:

1. A seed metering apparatus comprising:
a seed hopper;
a seed cup operatively connected to said seed hopper via an opening;
a bi-directional member for closing said opening; and
a solenoid, operatively connected to said bi-directional member, to move said bi-directional member between an open state and a closed state; said open state corresponding to said opening being open and said closed state corresponding to said opening being closed.

2. The seed metering apparatus, as claimed in claim 1, further comprising a seed tube operatively connected to said seed cup.

3. The seed metering apparatus, as claimed in claim 2, wherein said seed cup includes a metering mechanism to regulate a flow of seed into said seed tube.

4. The seed metering apparatus, as claimed in claim 1, further comprising a manual controller to manually control said solenoid.

5. The seed metering apparatus, as claimed in claim 1, further comprising a global positioning satellite based controller to automatically control said solenoid.

6. The seed metering apparatus, as claimed in claim 4, further comprising a global positioning satellite based controller to automatically control said solenoid.

7. The seed metering apparatus, as claimed in claim 6, wherein said manual controller is configured to override said global positioning satellite based controller.

8. A seed metering apparatus comprising:
a seed hopper;
a seed cup operatively connected to said seed hopper via an opening; and
a valve mechanism, operatively connected between said seed hopper and said seed cup, configured to control a flow of seed from said seed hopper to said seed cup.

9. The seed metering apparatus, as claimed in claim 8, wherein said valve mechanism includes a bi-directional member and a solenoid, operatively connected to said bi-directional member, to move said bi-directional member between an open state and a closed state; said open state corresponding to said valve mechanism being open and said closed state corresponding to said valve mechanism being closed.

10. The seed metering apparatus, as claimed in claim 8, further comprising a seed tube operatively connected to said seed cup.

11. The seed metering apparatus, as claimed in claim 10, wherein said seed cup includes a metering mechanism to regulate a flow of seed into said seed tube.

12. The seed metering apparatus, as claimed in claim 8, further comprising a manual controller to manually control said valve mechanism.

13. The seed metering apparatus, as claimed in claim 8, further comprising a global positioning satellite based controller to automatically control said valve mechanism.

14. The seed metering apparatus, as claimed in claim 12, further comprising a global positioning satellite based controller to automatically control said valve mechanism.

15. The seed metering apparatus, as claimed in claim 14, wherein said manual controller is configured to override said global positioning satellite based controller.
